(19) United States
(12) Patent Application Publication
(10) Pub. No.: US 2015/0072662 A1
(43) Pub. Date: Mar. 12, 2015

(54) RESUMPTION OF DATA CONNECTIVITY BETWEEN MOBILE DEVICES VIA SWITCHING APPLICATION

(71) Applicant: NVIDIA Corporation, Santa Clara, CA (US)

(72) Inventors: Siddarth Chandrasekaran, Mumbai (IN); Rameez Syed, Achampet (IN); Mahesh Meena, Ambernath (IN)

(73) Assignee: NVIDIA Corporation, Santa Clara, CA (US)

(21) Appl. No.: 14/021,911

(22) Filed: Sep. 9, 2013

(51) Int. Cl. H04W 8/08

(52) U.S. Cl. CPC H04W 8/08
USPC 455/414.1

(57) ABSTRACT

The disclosure is directed to systems and methods for switching a data downloading session from a first mobile device to a second mobile device. The data downloading session first commences on the first mobile device. During the session, a download transfer condition is identified. In response, the first mobile device sends the second mobile device download resumption information, which is specifically adapted to enable the second mobile device to continue the data downloading session without having to restart an interrupted downloading operation.

### BACKGROUND

Cellular and other wireless networks enable transmitting and receiving data via mobile devices such as smart phones, laptop computers, tablets, and other portable computing devices. Often, cellular networks are accessed while a user is mobile, which can cause the connection status between the mobile device and the cellular network to vary. For example, a user may move into an area that is out of range of a base station of the cellular network, an area that generates interference affecting the wireless communication capabilities of the mobile device, or an area outside of a home network of the user, causing the mobile device to enter a roaming state.

Under such conditions, a data downloading session may be paused, terminated, slowed, or otherwise interrupted or degraded until communication is restored between the mobile device and the cellular network. In these cases, a user may have to wait for an interrupted downloading operation to complete or restart the interrupted downloading operation manually when the data connection has been restored. Under roaming conditions, a data downloading session may be more costly than when not roaming, and a user may choose to pause the session until once again on the home network. These interruptions and delays are generally undesirable and can cause user frustration.

Oftentimes, the user will have an additional device that is somehow capable of performing the download, for example a device that has a stronger connection or that is not roaming. However, performing the download on this second device typically requires various manual steps that are time-consuming, and/or the interrupted operation has to be restarted such that progress gained on the first mobile device is lost.

### BRIEF DESCRIPTION OF THE DRAWINGS

FIG. 1A shows an example data downloading environment for multiple mobile devices, in accordance with embodiments of the present disclosure.

FIG. 1B shows an example data downloading environment for mobile devices moving within the environment, in accordance with embodiments of the present disclosure.

FIG. 2 shows an example interrupted downloading operation including a persistent file download, in accordance with embodiments of the present disclosure.

FIG. 3 shows an example interrupted downloading operation including a streaming data transfer, in accordance with embodiments of the present disclosure.

FIG. 4 is a flow chart for a method of automatically switching a data download session between a first mobile device and a second mobile device, in accordance with embodiments of the present disclosure.

FIG. 5 is a block diagram of an application for automatically switching a data download session between a first mobile device and a second mobile device, in accordance with embodiments of the present disclosure.

FIG. 6 is a block diagram of a computing device, in accordance with embodiments of the present disclosure.

### DETAILED DESCRIPTION

This description is directed to switching a data downloading session from a first mobile device to a second mobile device. Specific examples of downloading include downloading a file or streaming content to the first device. During the download, a “download transfer condition” is identified automatically. Generally speaking, the download transfer condition corresponds to a situation where it is preferable to conduct the download on the second device instead of the first device. The download might stall on the first device, for example, or the first device might enter a more costly roaming state. The two devices may communicate actively with one another in order to identify the download transfer condition. The first device then sends the second device download resumption information, which is specifically adapted to enable the second device to pick up where the first device left off, i.e., resuming the download without the second device having to restart the interrupted download operation.

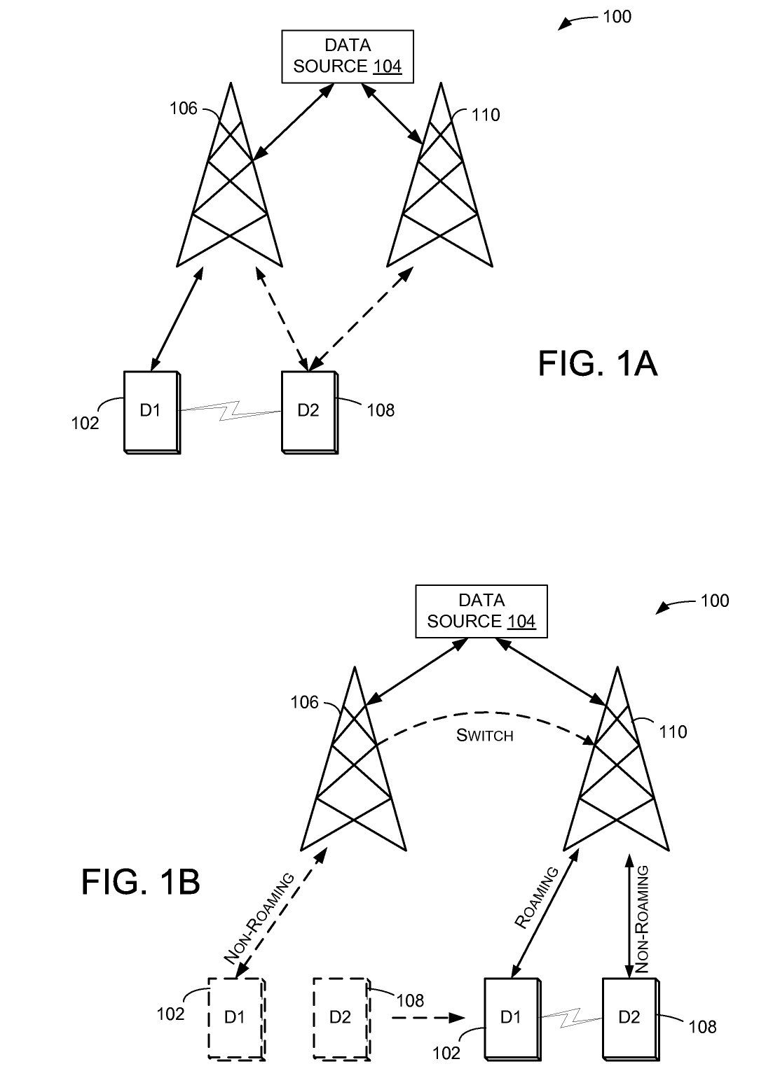

Turning now to FIGS. 1A and 1B, the figures show two mobile devices in example environments in which it may be desirable to transfer a downloading session between mobile devices. As discussed above, mobile devices may access a cellular or other wireless network in order to provide a data downloading session for a user. A data downloading session may include one or more downloading operations, non-limiting examples of which include a streaming data transfer or a persistent file download. As illustrated in FIG. 1A, a data downloading environment 100 may include a first mobile device 102 that is connected to a data source 104 for a data downloading session via a first base station 106. Mobile devices discussed herein may be connected to base stations via any suitable communication standard, including but not limited to 2G, 3G, and/or 4G cellular networking standards. Data source 104 may be directly or indirectly connected to the first base station 106 (e.g., via a network). The first mobile device 102 may also be connected to a second mobile device 108 via a network and/or via a proximity-based communication protocol, such as BLUETOOTH and/or Near Field Communication (NFC). The second mobile device 108 may be connected to the first base station 106 and/or to a second base station 110. The first and second mobile devices 102 and 108 may include any suitable mobile device, such as a mobile phone (e.g., smart phone), a tablet, a laptop computer, a portable gaming console, an e-reader, and/or any other portable device that may be connected to a network for providing a data downloading session. Further, in some embodiments, one or more of the first and second mobile devices may correspond to a substantially stationary device, such as a desktop computer or home entertainment system.

In embodiments including a first and second mobile device connected to the same base station (e.g., the first base station 106), a connection status of the two mobile devices may vary based on capabilities of each mobile device and/or cellular network subscriptions associated with each mobile device. In embodiments including a first and second mobile device connected to different base stations (e.g., the first mobile device 102 is connected to the first base station 106 while the second mobile device 108 is connected to the second base station 110), a connection status of the two mobile devices may additionally or alternatively vary based on relative location of each mobile device to the associated base station and/or the speed/strength of the cellular communication service provided by each base station. Data downloading sessions may be automatically switched between the two devices based on dynamic connection status conditions of the mobile devices, regardless of whether the devices are connected to the same or to separate base stations. In the example of FIG. 1A, changing performance conditions may cause the devices to recognize a download transfer condition, in which it is preferable to switch the session from the first device to the second device. In connection with the switch, the first device provides download resumption information to enable the second device to pick up the data downloading session where the first device left off, i.e., without having to restart an interrupted download operation.

FIG. 1B illustrates the data downloading environment 100 after the first and second mobile devices 102 and 108 move to a location at which both devices are serviced by the second base station 110. As shown, while the first mobile device 102 is connectable to the first base station 106 in a non-roaming state, the transition from the first base station 106 to the second base station 110 causes the first mobile device 102 to enter a roaming state. For example, the first base station 106 may provide cellular service to a home network of the first mobile device 102, while the second base station 110 may provide cellular service via an out-of-network provider for the first mobile device. In contrast, in the example illustrated, the second mobile device 108 connects to a home network via the second base station 110, such that it is not roaming. This might occur, for example, if the first and second mobile devices subscribe to cellular networks via two different cellular network providers.

In any case, when the roaming/non-roaming condition shown in FIG. 1B occurs, the devices recognize a download transfer condition, in which it is preferable to conduct the session on the second device (e.g., due to the less costly non-roaming state). Download resumption information is then passed to the second device, to enable the second mobile device to pick up the data downloading session where the first mobile device left off, without having to restart the download operation that was interrupted by the roaming status change of the first device.

Although the above examples are described with reference to cellular networks, it is to be understood that the methods and systems described herein may be performed while one or more of the mobile devices are connected to a wireless network other than a cellular network (e.g., via a WI-FI connection).

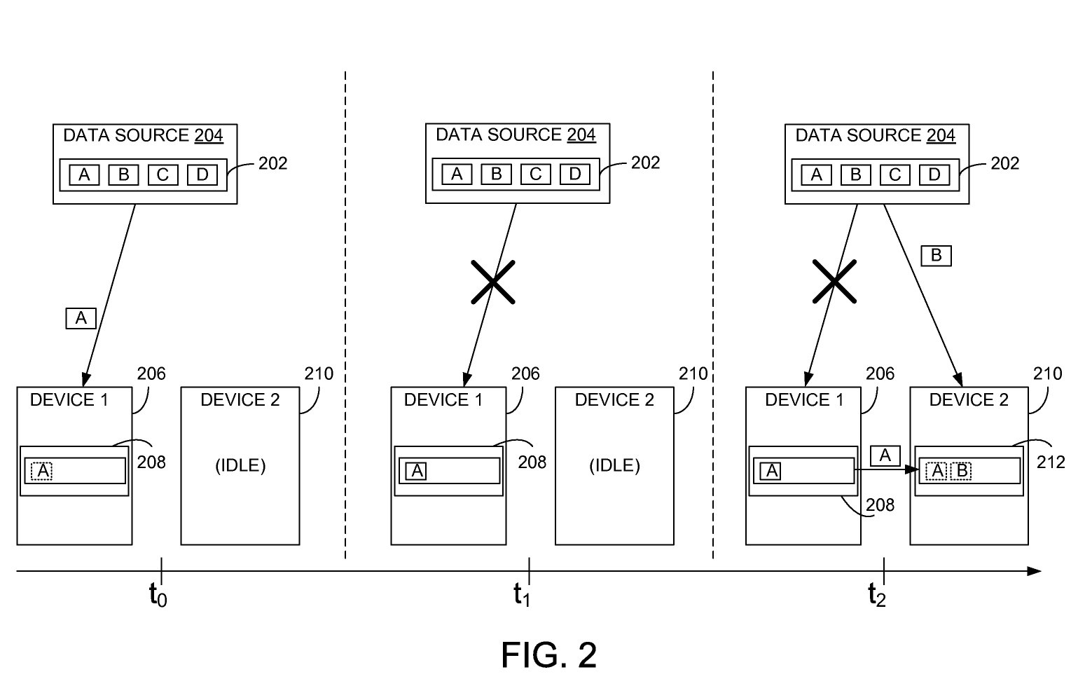

FIG. 2 illustrates an example of an interrupted downloading operation including a persistent file download 202. The persistent file download 202 may be stored at a data source 204 and may include one or more portions, such as portions A, B, C, and D. In some embodiments, the persistent file download may include a single file, each portion corresponding to a group of bits of the file. In other embodiments, the persistent file download may include multiple files, each portion corresponding to one or more of the multiple files and/or a collection of bits of a particular file. The persistent file download may be divided evenly, such that each portion includes the same number of bits or files, or the persistent file download may be divided unevenly. Data source 204 may include any suitable data source, such as a remote service and/or remote computing device accessible via a network, and may correspond to data source 104 of FIGS. 1A and 1B.

At time t₀, data source 204 sends a first portion (e.g., portion A) of the persistent file download 202 to a first mobile device 206. For example, the first mobile device may receive the first portion of the persistent file download for storage at a storage device 208 of the first mobile device 206. While the first mobile device 206 is performing the download operation, a second mobile device 210, which may be local to the first mobile device 206, may be in an idle or inactive state. For example, the second mobile device 210 may have a data connection enabled, but may not be participating in the data downloading session being conducted at the first mobile device 206.

Continuing with FIG. 2, at time t₁, the downloading operation of the first mobile device 206 is interrupted. For example, the first mobile device 206 may lose a connection to the data source 204, experience a degraded signal to a network connecting the first mobile device and the data source, enter a roaming state, and/or otherwise experience an undesirable change in connection status. The first mobile device 206 has received and is storing a first portion of the persistent file download 202 (i.e., portion A), but the remaining portions have not been downloaded to the first device. At time t₂, the data downloading session is switched from the first mobile device 206 to the second mobile device 210. In order to ensure that the second mobile device 210 is able to continue the data downloading session without having to restart the interrupted downloading operation, the first mobile device sends download resumption information that enables the second mobile device 210 to locate and connect to the data source 204 and begin receiving the non-downloaded portions of the persistent file download 202 (e.g., portions B, C, and D). Thus, as illustrated, the data source 204 may begin the data downloading session with the second mobile device 210 by sending a second portion (e.g., portion B) of the persistent file download 202 for storage at storage device 212 of the second mobile device 210. The first mobile device 206 may send the downloaded portions of the persistent file download (e.g., portion A) directly to the second mobile device 210 so that the second mobile device may store the complete persistent file download upon completion of the interrupted downloading operation.

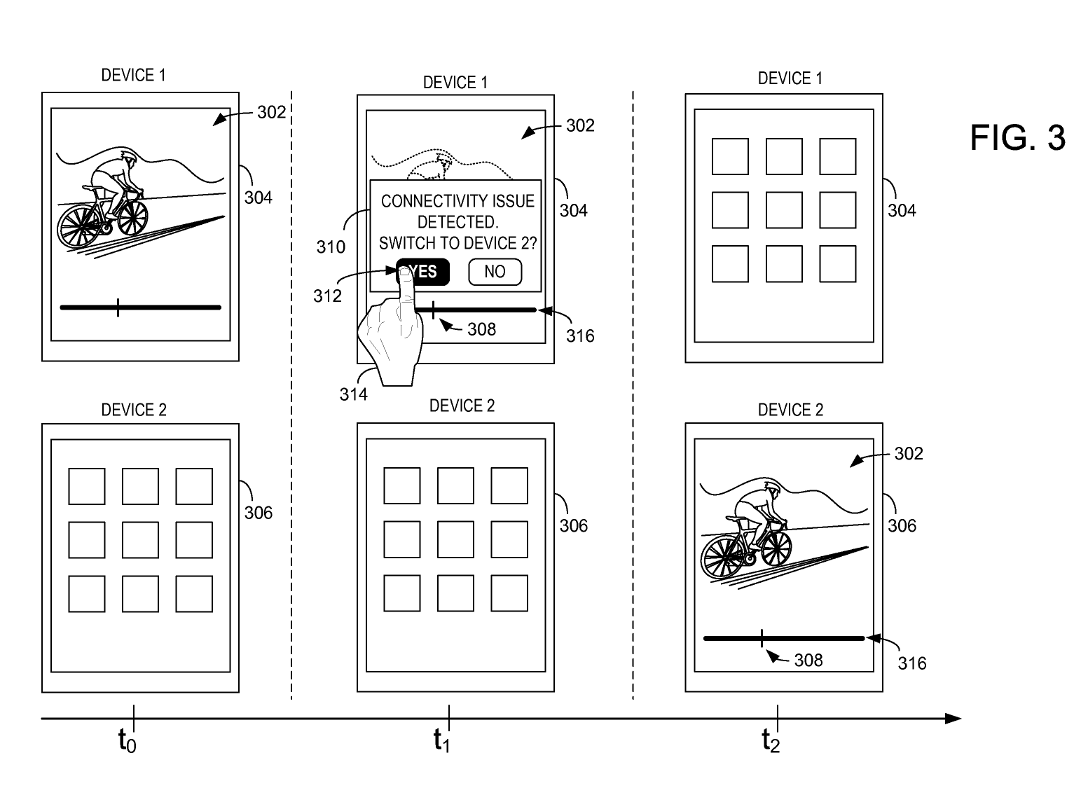

FIG. 3 illustrates an example of an interrupted downloading operation including a streaming data transfer. At time t₀, a user is performing a streaming data transfer, such as streaming video 302, on a first mobile device 304 while a second mobile device 306 is idle or otherwise not involved in the streaming data transfer. As shown at time t₁, at interruption point 308 of the streaming data transfer, connectivity of the first mobile device 304 to a network is lost, slowed, interrupted, or otherwise degraded, or the first mobile device 304 enters a roaming state. The change in connectivity status may optionally be indicated with a message 310. In some embodiments, the message may include a graphical user interface element detailing the specific connectivity issue (e.g., loss of connectivity, entry into roaming state, etc.), while in other embodiments, the graphical user interface element may be generic to all types of connectivity issues. Further, the message may provide a prompt to allow user authorization of a data downloading session transfer in some embodiments. For example, if presented on a touch sensitive display device, the message may include control elements, such as virtual button 312, operable by touch input from a user 314 to approve and/or deny the session transfer. In additional or alternative embodiments, user input to approve and/or deny the session transfer may be received by any suitable user input device, including but not limited to a mouse, keyboard, remote, microphone, motion sensor, camera, etc.

As shown at time t₃, the streaming video 302 is transferred to the second mobile device 306 responsive to approval from the user 314. Download resumption information may be transferred between the first and second mobile devices, enabling the second mobile device 306 to begin streaming the video 302 at the interruption point 308. In the illustrated example, the interruption point 308 corresponds to a frame of the streaming video 302 and is indicated on a video seek bar 316 as a progression of the video since the start of video playback. As illustrated, the second mobile device 306 may begin streaming the video at the same point on the seek bar (e.g., at the same frame) as the last frame shown on the first mobile device 304. Accordingly, a user may continue viewing the video without restarting the video or manually seeking the last viewed frame (e.g., via controls associated with the video seek bar 316).

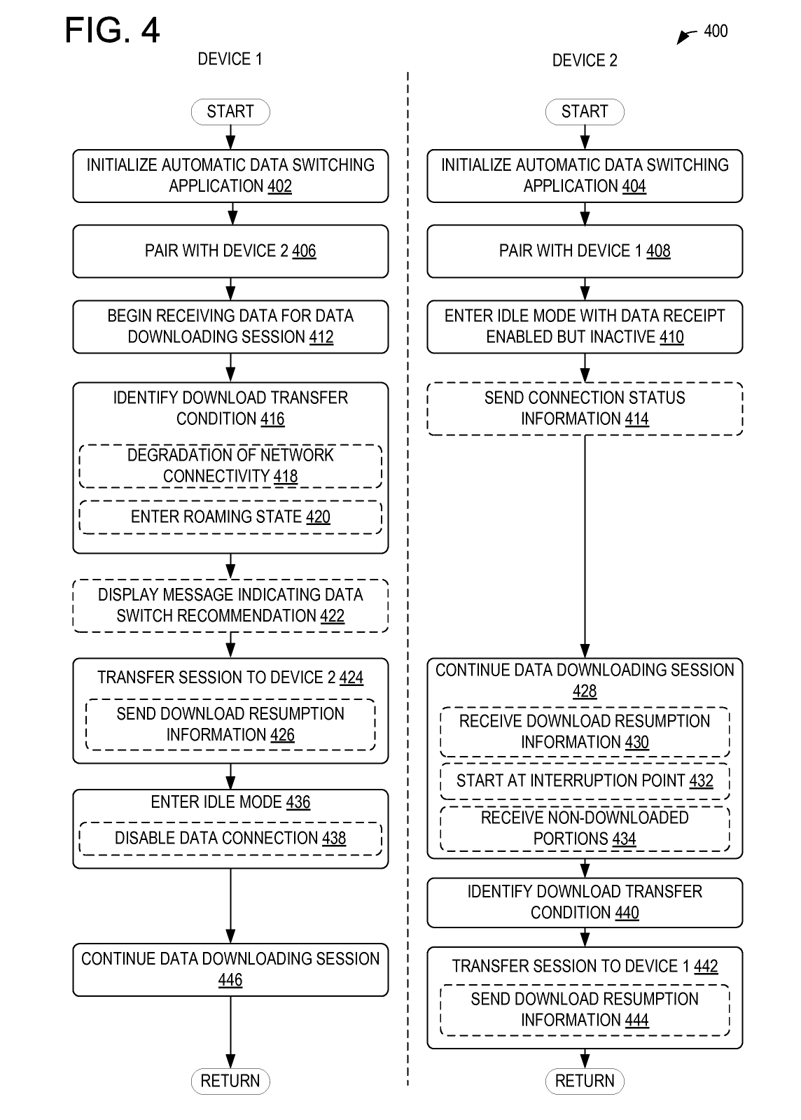

FIG. 4 is a flow chart for a method 400 of switching a data downloading session between a first mobile device and a second mobile device. Steps of the method 400 associated with “DEVICE 1” may be performed on a first mobile device, such as mobile device 102 of FIGS. 1A and 1B. Steps of the method 400 associated with “DEVICE 2” may be performed on a second mobile device, such as mobile device 108 of FIGS. 1A and 1B. At 402 and 404, the method 400 includes initializing an automatic data switching application on the first mobile device and the second mobile device, respectively. Initializing the automatic data switching application may include executing the application on each of the first and second mobile devices and configuring a wireless connection between the first and second mobile devices that enables the data switching applications to communicate. For example, the automatic data switching application may be used to pair the first mobile device with the second mobile device, as indicated at 406 and 408. In some embodiments, the automatic data switching application may provide a list of available mobile devices or otherwise allow a user to select the device for pairing. In additional or alternative embodiments, the application may automatically pair with devices in range of a mobile device, or automatically pair with devices with which the mobile device has previously paired (e.g., devices that are saved in a user-defined or automatically configured list of devices approved for automatically pairing).

After pairing with the first mobile device, the second mobile device may enter or be in an idle state in which a data connection may be enabled and inactive, as indicated at 410. For example, the second mobile device may maintain a connection with a network, but not participate in a data downloading session being conducted at first mobile device. “Idle,” as used herein, refers to the second device not participating in the first device's session. The second device may, however, participate in other data downloading sessions (e.g., different from data downloading sessions of the first mobile device) while in the idle state.

At 412, the method 400 includes beginning the data downloading session on the first mobile device. The data downloading session may include, as non-limiting examples, a persistent file download, as described above with respect to FIG. 2, and/or a streaming file transfer, as described above with respect to FIG. 3. During the data downloading session at the first mobile device, the second mobile device may send connection status information, as indicated at 414. For example, the second mobile device may send information indicating data transfer speed, signal strength, roaming status, and/or any other information indicating the suitability of the connection for handling a data downloading session. The connection status information may be sent responsive to the second mobile device entering the idle state, responsive to the first mobile device beginning a data downloading session, responsive to a request from the first mobile device, and/or at any other suitable time. In some embodiments, the connection status information may be sent periodically (e.g., at regular intervals) and/or responsive to a trigger, such as a change in connection status that exceeds a particular threshold. Connection status information may also be sent from the first mobile device to the second mobile device in any suitable manner, including those described above.

As indicated at 416, the method 400 includes identifying a download transfer condition. The download transfer condition in general corresponds to an indication that conducting the downloading session on the second mobile device is preferable. For example, the download transfer condition may be a degradation of network connectivity, as indicated at 418. In some embodiments, the degradation of network connectivity may be a relative degradation of connectivity of the first mobile device compared to a predetermined (e.g., user- or application-defined) threshold. In other embodiments, the degradation of network connectivity may be a relative degradation of connectivity of the first mobile device compared to the second mobile device. For example, identifying the download transfer condition may include comparing speed and/or strength of the connection of the first mobile device to a network to the speed and/or strength of the connection of the second mobile device to a network (e.g., as indicated in the communicated connection status information received at the first mobile device). It is to be understood that the comparison may occur at the first and/or the second mobile device. As indicated at 420, identifying the download transfer condition may include detecting that the first mobile device entered a roaming state.

As indicated at 422, the method 400 may include, responsive to identifying a download transfer condition, displaying or otherwise outputting a message at the first mobile device indicating a data switch recommendation, such as the message 310 of FIG. 3. In some embodiments, a message may be output on the second mobile device to confirm the session switch. Upon identifying the download transfer condition at 416 and/or receiving authorization from the user at 422, the method 400 includes transferring the data downloading session to the second mobile device at 424. The transferring may include sending download resumption information configured to enable the second mobile device to continue the data downloading session without having to restart an interrupted downloading operation. For example, the download resumption information may include an address or other identifier to enable the second mobile device to locate the data source providing data for the downloading operation of the data downloading session. The download resumption information may also include an indication of downloaded portions of the persistent file download or an indication of an interruption point in the streaming data transfer in order to allow the second mobile device to pick up with the interrupted downloading operation at the point at which the first device stopped receiving data for the interrupted downloading operation. As described above with respect to FIG. 2, the downloaded portions of a persistent file download may be sent to the second mobile device from the first mobile device (e.g., via a proximity-based data connection). The sending of the downloaded portions may occur before, after, and/or simultaneously with the download resumption information. For example, the downloaded portions may be sent from the first mobile device to the second device responsive to a completion of the persistent file download at the second mobile device in order to ensure an economic usage of the data connection between the two devices.

At 428, the method 400 includes continuing the data downloading session at the second mobile device. For example, continuing the data downloading session may include receiving the download resumption information, as indicated at 430, and beginning to receive data for the downloading session. As indicated at 432, the data downloading session may be started at an interruption point for streaming data transfers, or may include receiving non-downloaded portions for persistent file downloads, as indicated at 434. After transferring the session to the second mobile device (e.g., immediately upon sending download resumption information or upon confirming that the data downloading session is continued at the second mobile device), the method 400 may include entering an idle mode at the first mobile device. For example, if the first mobile device is in a roaming mode, the data connection may be disabled as indicated at 438 in order to avoid charges from a network provider. In additional or alternative embodiments, entering the idle mode may include disconnecting from the data downloading session or otherwise not receiving data from the data downloading session. It is to be understood that in some embodiments (e.g., when the first mobile device is not in a roaming state), the first mobile device may continue receiving data for the data downloading session in order to provide a backup data connection. The first mobile device may continue sending connection status information to the second mobile device after transferring the data downloading session to the second mobile device.

As indicated at 440, the method 400 may include identifying a download transfer condition at the second mobile device. For example, the first and/or second mobile device may perform similar evaluations to those described above with respect to step 416 in order to determine which device is more suitable to perform the downloading operation of the data downloading session. In some embodiments, thresholds and/or other criteria for identifying the download transfer condition may be altered based on a number of transfers between devices. For example, identifying the download transfer condition at step 440 may only be performed if the second mobile device experiences a complete data connection loss (e.g., a data transfer speed of 0 kilobits per second), whereas identifying the download transfer condition at step 416 may be performed if the first mobile device experiences a decrease in data transfer speed (e.g., to a data transfer speed that is below a threshold and above 0 kilobits per second). The download transfer condition may thus be altered based on how many transfers have occurred for a given interrupted download operation and/or data downloading session. In some embodiments, only a threshold number of downloading session transfers may be allowed for a given interrupted download operation and/or data downloading session.

Responsive to identifying the download transfer condition at 440, the method 400 includes transferring the data downloading session from the second mobile device to the first mobile device, as indicated at 442. The transfer may include sending download resumption information at 444 configured to enable the first mobile device to continue the data downloading session without having to restart an interrupted downloading operation. In some embodiments, the download resumption information sent at 444 may be an updated version of the download resumption information sent at 426, including a new indication of an interruption point and/or downloaded portions of a persistent file download. As indicated at 446, the first device may continue the data downloading session based on the download resumption information received from the second mobile device without having to restart the interrupted downloading operation. Although only two data downloading session transfers between two devices are described with reference to FIG. 4, it is to be understood that any suitable number of data downloading session transfers may occur between any number of devices.

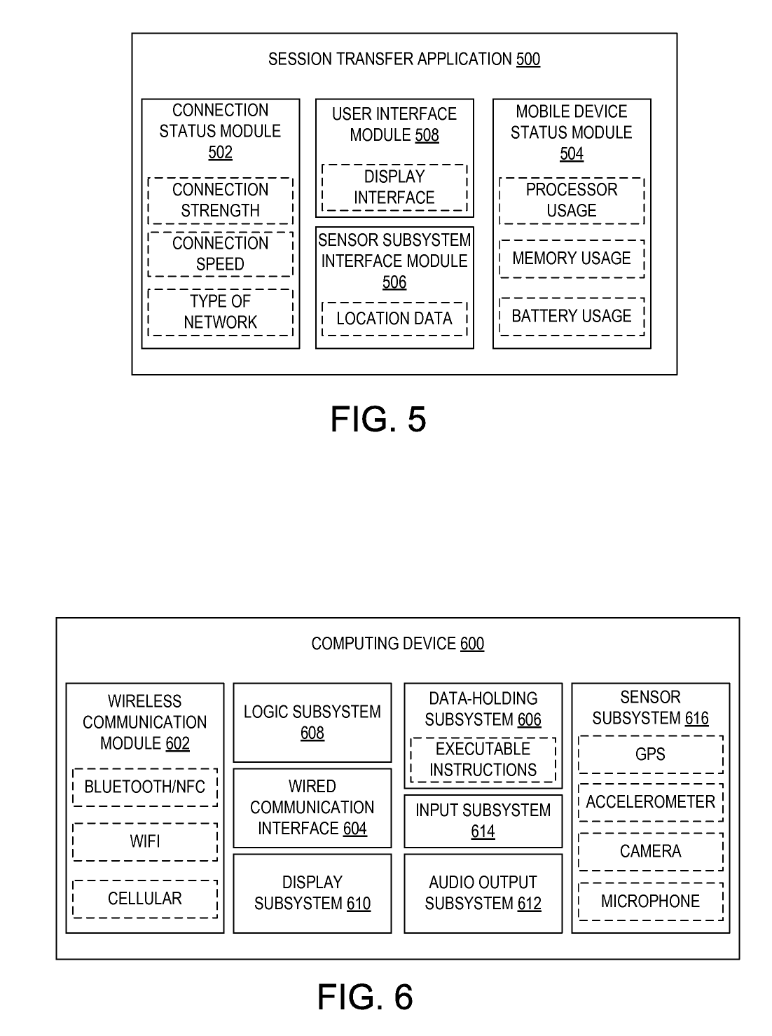

FIG. 5 shows a block diagram of an automatic data downloading session transfer application 500. The automatic data downloading session transfer application 500 may enable data downloading sessions to be transferred between devices with no user input or with only user input to provide authorization. The session transfer application 500 may be stored and executed (and thus ran) on a mobile device, such as the first and second mobile devices 102 and 108 of FIGS. 1A and 1B. As indicated in FIG. 5, the session transfer application 500 may include a connection status module 502 to monitor parameters such as connection strength, connection speed, type of network (e.g., to determine whether the device is roaming), and/or any other information related to the connection status of the mobile device to indicate the suitability of the mobile device for handling a particular data downloading session (e.g., to identify a download transfer condition). The connection status module may monitor and/or query one or more hardware and/or software elements of the mobile device in order to determine the above-described connection status parameters.

In some embodiments, the connection status of the mobile device may be supplemented with information from a mobile device status module 504 and/or a sensory subsystem interface module 506 to assist in identifying a download transfer condition. For example, the mobile device may access one or more hardware and software elements of the mobile device in order to determine processor usage, memory usage, battery usage, data usage limit (e.g., as defined by a network provider) and/or any other mobile device system that may affect a downloading operation. For example, if the available memory, processor, and/or battery is below a threshold, the mobile device may be less able to handle a downloading operation than a mobile device with excess resources. In some embodiments, the application may acquire location data (e.g., from a global positioning service [GPS] system of the mobile device) in order to determine a likely change in connection status based upon historical connection status data associated with the location of the mobile device. For example, if the mobile device enters a location in which a connection was lost in prior data downloading sessions, the location data may be used to identify a download transfer condition. In some embodiments, the information from the connection status module 502, the mobile device status module 504, and/or the sensor subsystem interface module 506 may be assigned different weights, and a download transfer condition may be identified if a weighted score from the referenced modules exceeds a threshold.

The session transfer application 500 may also include a user interface module 508 for enabling a user to configure and/or otherwise interact with the application. The user interface module 508 may define and control a graphical user interface displayed on a display of the mobile device. The user interface module 508 may interpret user input provided to the mobile device in order to configure and/or control the application during use.

FIG. 6 is a block diagram of a computing device 600 in accordance with embodiments of the present disclosure. For example, the computing device 600 may correspond to any of the mobile devices described above, including the first and second mobile devices 102 and 108 of FIGS. 1A and 1B. The computing device 600 may include a wireless communication module 602 for enabling wireless communication via one or more wireless communication protocols. For example, the wireless communication module 602 may enable communication via proximity-based protocols, such as BLUETOOTH or Near-Field Communication (NFC) between local devices. The wireless communication module 602 may also enable communication via WI-FI and/or cellular networks to allow the computing device 600 to connect to a data source for a data downloading session. The computing device may include a wired communication interface 604 for wired communications between devices via Universal Serial Bus (USB), Ethernet, Firewire, and/or any other suitable wired communications protocol.

The computing device 600 may include executable instructions stored on a data-holding subsystem 606 for performing one or more of the methods described herein. For examples, the executable instructions may be executable by a logic subsystem 608 to provide the application 500 of FIG. 5 and/or to perform the method 400 of FIG. 4. The data-holding subsystem may include one or more volatile and/or non-volatile storage devices and the logic subsystem 608 may include one or more processors having one or more processing cores. The computing device 600 may include a display subsystem 610, which may include one or more display devices for providing visual output to a user. The computing device 600 may also include an audio output subsystem, which may include one or more audio output devices, such as speakers, for providing audible output to a user.

A user may interact with the computing device 600 via an input subsystem 614 and/or a sensor subsystem 616. In some embodiments, the input subsystem 614 may interpret information from the sensor subsystem 616 in order to control the computing device based on user input. For example, the input subsystem may receive signals from a touch-sensitive device, a camera, a microphone, etc., to control the computing device 600 based on user input such as touch input, gesture input, voice commands, etc. The sensor subsystem 616 may include any suitable sensor element, including but not limited to a GPS and one or more accelerometers, cameras, and microphones.

It will be appreciated that methods described herein are provided for illustrative purposes only and are not intended to be limiting. For example, as used herein, the terms “first,” “second,” etc. are provided as labels to differentiate elements from one another, and are not intended to limit the elements to a particular order or provide numerical requirements for the elements. Accordingly, it will be appreciated that in some embodiments the methods described herein may include additional or alternative processes, while in some embodiments, the methods described herein may include some processes that may be reordered, performed in parallel or omitted without departing from the scope of the present disclosure. Further, it will be appreciated that the methods described herein may be performed using any suitable software and hardware in addition to or instead of the specific examples described herein. This disclosure also includes all novel and non-obvious combinations and sub-combinations of the above systems and methods, and any and all equivalents thereof.

1. A method for switching a data downloading session from a first mobile device to a second mobile device, comprising:
pairing the first mobile device with the second mobile device;
beginning the data downloading session on the first mobile device;
identifying, at the first mobile device, a download transfer condition;
in response to the download transfer condition, sending, from the first mobile device to the second mobile device, download resumption information configured to enable the second mobile device to continue the data downloading session without having to restart an interrupted downloading operation.

2. The method of claim 1, wherein the download transfer condition includes the first mobile device entering a roaming state.

3. The method of claim 2, further comprising:
continuing the data downloading session on the second mobile device;
determining that the first mobile device has entered a non-roaming state; and
in response to the first mobile device entering the non-roaming state, sending, from the second mobile device to the first mobile device, download resumption information configured to enable the first mobile device to continue the data downloading session without having to restart an interrupted downloading operation.

4. The method of claim 1, wherein the download transfer condition includes a degradation of network connectivity at the first mobile device.

5. The method of claim 4, further comprising:
continuing the data downloading session on the second mobile device;
determining an improvement in network connectivity has occurred at the first mobile device; and
in response to the improvement in network connectivity at the first mobile device, sending, from the second mobile device to the first mobile device, download resumption information configured to enable the first mobile device to continue the data downloading session without having to restart an interrupted downloading operation.

6. The method of claim 1, further comprising prompting a user to authorize continuing the data downloading session at the second mobile device.

7. The method of claim 1, wherein the interrupted downloading operation is a persistent file download and the download resumption information includes an indication of downloaded portions of the persistent file download, the method further comprising instructing the second mobile device to download only non-downloaded portions of the persistent file download.

8. The method of claim 7, further comprising sending the downloaded portions of the persistent file download from the first mobile device to the second mobile device.

9. The method of claim 1, wherein the interrupted downloading operation is a streaming data transfer and the download resumption information includes an indication of an interruption point in the streaming data transfer, the method further comprising instructing the second mobile device to resume the streaming data transfer at the interruption point.

10. The method of claim 1, wherein pairing the first mobile device and the second mobile device includes executing an automatic session switching application on each of the first mobile device and the second mobile device and configuring a wireless connection between the first mobile device and the second mobile device to enable communication via the automatic session switching applications.

11. The method of claim 1, wherein identifying the download transfer condition includes communicating connection status information between the first mobile device and the second mobile device, the method further comprising determining, based on the communicated connection status information, that performing the data downloading session via the second mobile device is preferable to performing the data downloading session via the first mobile device.

12. The method of claim 11, wherein determining that performing the data downloading session via the second mobile device is preferable to performing the data downloading session via the first mobile device includes determining that network connectivity is superior at the second mobile device.

13. The method of claim 11, wherein determining that performing the data downloading session via the second mobile device is preferable to performing the data downloading session via the first mobile device includes determining that the second mobile device is in a non-roaming state.

14. A mobile computing system comprising:
a wireless communication module;
a logic subsystem; and
a data-holding subsystem storing executable instructions configured to:
pair the mobile computing system with a local mobile device;
begin a data downloading session on the mobile computing system;
identify, at the mobile computing system, a download transfer condition; and
in response to the download transfer condition, send, from the mobile computing system to the local mobile device, download resumption information configured to enable the local mobile device to continue the data downloading session without having to restart an interrupted downloading operation.

15. The method of claim 14, wherein identifying the download transfer condition includes communicating connection status information between the mobile computing system and the local mobile device, the method further comprising determining, based on the communicated connection status information, that performing the data downloading session via the local mobile device is preferable to performing the data downloading session via the mobile computing system.

16. The system of claim 15, wherein determining that performing the data downloading session via the local mobile device is preferable to performing the data downloading session via the mobile computing system includes determining that network connectivity is superior at the local mobile device.

17. The method of claim 15, wherein determining that performing the data downloading session via the local mobile device is preferable to performing the data downloading session via the mobile computing system includes determining that the local mobile device is in a non-roaming state.

18. In a first mobile device, a method for switching a data downloading session from the first mobile device to a second mobile device, the method comprising:
pairing the first mobile device with the second mobile device;
beginning the data downloading session on the first mobile device;
receiving data from the second mobile device indicating a connection status of the second mobile device;
determining, based on the communicated connection status, that performing the data downloading session via the second mobile device is preferable to performing the data downloading session via the first mobile device; and
sending, from the first mobile device to the second mobile device, download resumption information configured to enable the second mobile device to continue the data downloading session without having to restart an interrupted downloading operation.

19. The method of claim 18, wherein determining that performing the data downloading session via the first mobile device is preferable to performing the data downloading session via the second mobile device includes determining, based on the communicated connection status, that network connectivity is superior at the second mobile device.

20. The method of claim 18, wherein determining that performing the data downloading session via the second mobile device is preferable to performing the data downloading session via the first mobile device includes determining, based on the communicated connection status, that the second mobile device is in a non-roaming state.
